(19) United States
(12) Patent Application Publication
(10) Pub. No.: US 2008/0021753 A1
(43) Pub. Date: Jan. 24, 2008

(54) System and method for service oriented design process

(75) Inventor: Fred A. Cummins, Farmington Hills, MI (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/482,594

(22) Filed: Jul. 7, 2006

(51) Int. Cl. G06F 9/46

(52) U.S. Cl. 705/8

(57) ABSTRACT

A method for service-oriented design, including performing a role analysis, performing a services synthesis, performing an organization design, and transformation planning to produce a service oriented transformation plan. Also included is a related data processing system and computer program product.

### TECHNICAL FIELD OF THE INVENTION

The present invention is directed, in general, to service oriented design and analysis.

### BACKGROUND OF THE INVENTION

The Internet and web services technology have fostered a trend to design systems with a service oriented architecture (SOA). This was based on a strategy for enterprises to offer services to other enterprises over the internet with automated business transactions. This has evolved to a more generalized approach to integration of systems that encourages sharing of runtime functionality in the form of services. This is different from traditional integration of information technology (IT) services because the services are loosely coupled (exchanging asynchronous messages) and tend to provide capabilities of larger scope.

Consequently, service oriented architecture has become applicable to the general design of IT systems that realize the runtime sharing of capabilities. At the same time, business process management (BPM) and business process automation has become increasingly important to the streamlining of business operations, and application integration. Large, monolithic applications will be replaced by smaller applications or sub-systems directed and integrated by automated business processes. By combining concepts of BPM and SOA, services become business process driven, both in their implementation and in their integration. This requires an alignment of services with the design of the business. Organizations have responsibility aligned to services and the processes that implement them.

This alignment can provide not only agility in the IT systems, but corresponding agility in the enterprise, by enabling the usage and operation of services to be re-structured through the adaptation of business processes. The implementation of shared services enables the enterprise to achieve economies of scale and improve quality through specialization. It also enables off-shoring and out-sourcing of selected business functions as services.

Unfortunately, service oriented architectures are being developed by IT organizations without clear alignment to the business. At the same time, there is no well-defined discipline for definition of services.

There is, therefore, a need in the art for a system and method for analysis and design of the business that will provide a basis for business and IT transformation to a service oriented architecture driven by explicit business processes.

### SUMMARY OF THE INVENTION

In accordance with one disclosed embodiment, there is provided a method for service-oriented design, comprising performing a role analysis; performing a services synthesis; performing an organization design; and transformation planning to produce a service oriented transformation plan.

In accordance with another disclosed embodiment, there is provided a data processing system having at least a processor and accessible memory, comprising means for receiving role analysis data; means for receiving services data to perform a services synthesis; means for receiving organization design data; and means for receiving transformation planning data and to produce therefrom a service-oriented transformation plan.

In accordance with another disclosed embodiment, there is provided a computer program product tangibly embodied in a machine readable storage medium, comprising instructions for receiving role analysis data; instructions for receiving services data to perform a services synthesis; instructions for receiving organization design data; and instructions for receiving transformation planning data and to produce therefrom a service-oriented transformation plan.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented; and

FIG. 2 depicts a block diagram of four major phases and associated outputs in accordance with at least one disclosed embodiment.

### DETAILED DESCRIPTION OF THE INVENTION

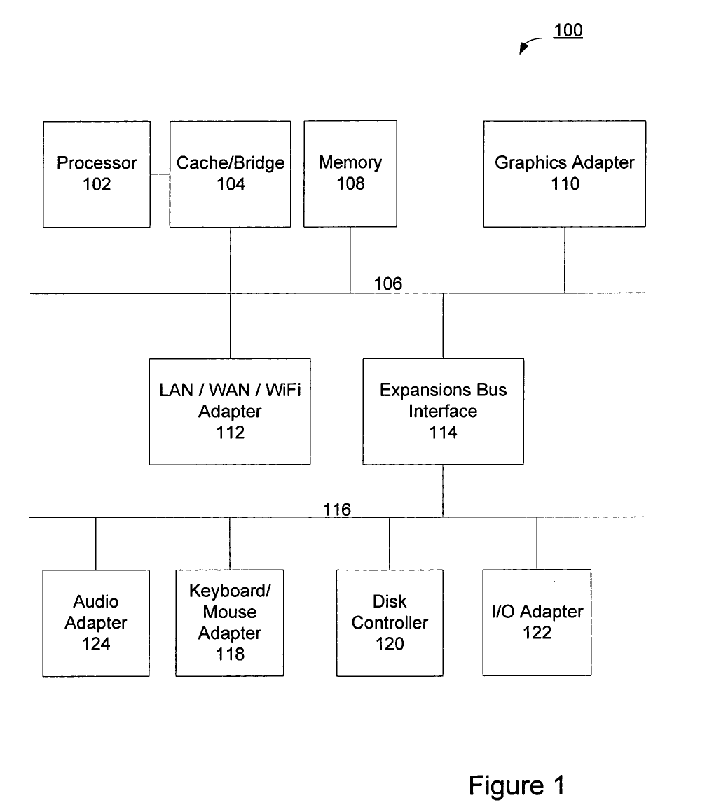

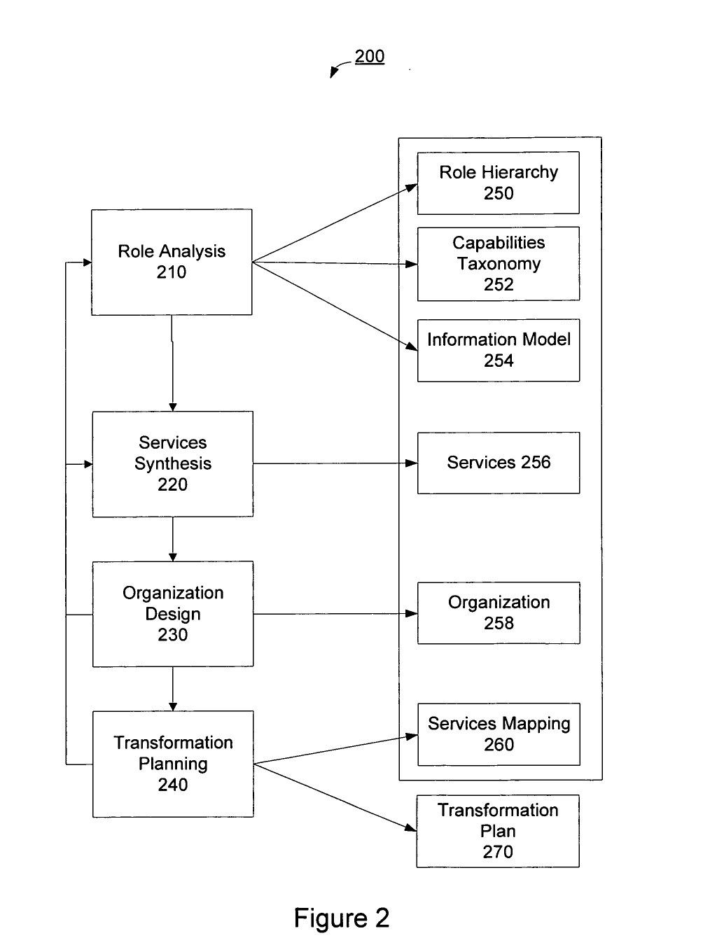

FIGS. 1 and 2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system 100 in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary in various embodiments. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed, for example, or it or another operating system may be suitably modified. The operating system can be modified or created in accordance with the present invention as described, though various embodiments can execute within the various operating systems as commercially available.

Various embodiments include a system and method for service oriented enterprise design.

A business enterprise, like any useful service, delivers value to its customers in one or more forms. This value may be services such as financial services or transportation services, or it may be products such as manufactured goods. In either case the enterprise has one or more value chains (a value chain being a high level business process) that produce the desired products or services. A value chain can be viewed as a composition of more specific services that add value to the customer product or service. Thus the enterprise can be viewed as a collection of integrated services that contribute to the delivery of value to customers. The challenge is to define the services to be integrated in a way that is efficient, responsive and adaptable.

FIG. 2 depicts a block diagram of four major phases and associated outputs in accordance with at least one disclosed embodiment. One process has four major phases as illustrated in FIG. 2 and described below. Each step, in various embodiments as described below, can also be performed in an interactive manner between one or more users and one or more data processing systems as depicted in FIG. 1, for data process system and computer program product implementations. Various data processing system and computer program product implementations can be useful in ensuring the consistency of the data captured, and in enabling similar roles to be more easily identified through identification of roles with similar characteristics.

FIG. 2, the boxes on the left depict phases, and the boxes on the right depict outputs. Many of the outputs of earlier phases are incorporated in later phases. The arrows on the left indicate that roles may be added or refined in later phases, i.e., the process can be iterative.

In some embodiments, an initial step includes a high-level business process role analysis 210. This may be the value chain of a business unit, or the value chain of the enterprise. Each of the segments or steps in the value chain is considered. For each segment, one or more high-level processes are outlined to identify the primary responsibilities within that segment.

These responsibilities are viewed as “roles” where a participant will fulfill that responsibility. A role is defined as the requirement for a participant to achieve a particular result. The objective of the role analysis 210 is to define roles independent of the existing organization structure and IT applications in order to perform an objective analysis.

A participant can fill a role, as a role can address the requirements in a context defined by the role. In general, the participant will have its own process for fulfilling the role. That participant process, in turn may have roles to achieve more detailed value contributions. This iterative analysis produces a role hierarchy 250. Each role defines a requirement for a participant to add value in a particular context.

The role analysis 210 continues until each role represents specific, tangible work that adds value. These roles for real work will be referred to herein as concrete roles. These roles require definition of specific capabilities, the inputs and resources needed and the outputs produced including the subject-matter or work product of the participant's activities.

In some embodiments, role analysis 210 defines activities where real, added-value work is accomplished and the context in which it is performed. This analysis is not constrained by organization structures in which work is currently done, nor is the goal to identify shared functions in this phase.

The participants in these concrete roles have capabilities that are used to satisfy the role requirement. These may be capabilities of humans or external organizations. A companion model captures a capabilities taxonomy 252 as the roles identify the needs for capabilities. These may often correspond to job classifications. The use of a taxonomy structure will encourage the use of consistent capability names and descriptions, and will be useful in the later service synthesis phase.

In addition, the definition of roles includes information exchanged between the role (or usage of a capability) and the participant, including information about the subject-matter or work product of the participant's activities. The role defines the context and requirements for the participant's responsibilities. The information exchanged is captured in an information model 254 so that the names, definitions and relationships of the elements are consistent among different roles that involve the same elements. The information model also supports the services synthesis, below.

In some embodiments, the role analysis 210 is particularly important as a process for capturing information, such as role hierarchy 250, capabilities taxonomy 252, and information model 254, as this information can be used in the remainder of the overall process.

Role analysis 210 can define the contexts in which work must be done, e.g., where a service might be used. This can include the requirement for what is to be done, i.e., the value to be added, the inputs and the outputs, and the capabilities and/or resources required, and other similar role information.

In a data processing system and computer program product implementation, in some embodiments, role analysis 210 can be an interaction in which the data processing system receives role analysis data and stores corresponding output data including one or more of the role hierarchy 250, capabilities taxonomy 252, and information model 254. The data processing system or computer program product can also perform other tasks or analysis as related to role analysis 210.

Various embodiments also include a services synthesis 220. The roles from the role analysis 210 are used to synthesize service requirements to produce a list of required services 256. Roles that have similar characteristics are brought together, such as roles requiring the same capabilities, the same resources, the same types of information, etc. Based on such similar roles, a service 256 is defined to fulfill similar roles.

The requirements for interactions between services 256 are defined. Services 256 may be invoked by other services or responsibility may be transferred from one service to another. The usage of a service may require a series of interactions to achieve the desired result. This is particularly an issue where requirements are complex, the services are performed by relatively independent organizations, or requirements may change over time.

The services synthesis 220 may uncover the need for a service to offer multiple operations, including such operations as request for change or cancellation. The services synthesis 220 may also uncover the need for additional roles to fulfill a service requirement, in which case the process can return to the role analysis 210.

In some embodiments, the service synthesis 220 includes the identification of similar roles, e.g., contexts in which a service could be used, to determine where a single service can meet the needs of multiple roles (e.g., the service can perform in multiple roles). The information model 254 can be used for recognizing the similarities. The service definition can determine in general terms how a shared service can meet the needs of multiple roles. This may cause some adjustments to the roles to align to shared service needs.

In a data processing system and computer program product implementation, in some embodiments, services synthesis 220 can be an interaction in which the data processing system receives services data, and one or more of the role hierarchy 250, capabilities taxonomy 252, and information model 254, and produces and stores output that can include services 256. The data processing system or computer program product can also perform other tasks or analysis as related to services synthesis 220. For example, the data processing system can combine the services data with a role hierarchy according to the role analysis data.

Various embodiments also include an organization design 230, in which the services defined above can be aligned to the enterprise organization to define an organization 258. This can be done by aligning to the existing organization, or in some embodiments, to achieve a more agile enterprise, it is appropriate to create a future or “straw man” organization 258 based on the services to be managed. Consequently, an organizational design 230 can be created from the bottom up.

Services are grouped into organizations 258 based on a number of factors, such as geography, economies of scale, authority, responsibility, skills, ownership or access to resources, degree of coupling between services, information requirements, motivation/organizational goals, separation of responsibility, etc. Where the work is currently being done can be a factor. The resources required can be a major factor. The roles (context in which the service is being used) can determine the relationship of one service to other services and can affect how closely related the services are and the need for close communication (level of coupling). Organizational alignment can also affect motivation and control (e.g., separation of responsibility).

In some embodiments, some services may be replicated in different organizations 258 due to such factors as the need to provide the service in multiple geographies. This is a matter of judgment and experience supported by details about the services.

In a data processing system and computer program product implementation, in some embodiments, organization design 230 can be an interaction in which the data processing system receives organization design data, and one or more of the role hierarchy 250, capabilities taxonomy 252, information model 254, and service 256, and produces and stores an output that can include organization 258. The data processing system or computer program product can also perform other tasks or analysis as related to organization design 230.

Various embodiments also include transformation planning 240. Transformation planning can consider both what should be transformed and when it should be transformed.

In some embodiments, the transformation planning 240 starts with mapping the defined services 256 to the existing organization and IT applications, or at least one of these, and any organizations 258 defined above, to produce services mapping 260 and service-oriented transformation plan 270. This will expose duplication, inconsistencies, and possibly gaps. It will support identification of opportunities to achieve improved consistency for process improvement and economies of scale.

The results can be considered from two perspectives: (1) where is the greatest return on investment or competitive advantage, and (2) what services should be left where they are with the possible enhancement of providing improved interfaces to support sharing.

In the process of mapping, requirements for additional services 256 may be uncovered, or the need for more operations on individual services, in which case the process can return to service synthesis 220. Similarly, the transformation planning can reveal the need for more roles, in which case the process can return to role analysis 210.

In this way, the whole process is iterative in that as progress is made, new roles may be identified, new opportunities for shared services may be identified, and alignment to current or future organizations may cause a re-factoring of responsibilities, resulting in new or modified roles and services.

In various embodiments, the transformation plan 270 plan then becomes a matter of setting priorities and determining investments. As the transformation focuses on specific services 256, those services should be developed in greater detail. There is no need to develop detailed specifications for services that are not yet affected by the transformation. These detailed specifications include business process detail, exception and error handling, choreography to describe complex process interactions, and potentially more operations, roles and shared services.

In a data processing system and computer program product implementation, in some embodiments, transformation planning 240 can be an interaction in which the data processing system receives transformation planning data, and one or more of the role hierarchy 250, capabilities taxonomy 252, information model 254, services 256, and organization 258, and produces and stores an output that can include services mapping 260 and transformation plan 270. The data processing system or computer program product can also perform other tasks or analysis as related to transformation planning 240.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of the disclosed data processing system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for service-oriented design, comprising:
performing a role analysis;
performing a services synthesis;
performing an organization design; and
transformation planning to produce a service oriented transformation plan.

2. The method of claim 1, wherein the role analysis produces at least one of a role hierarchy, a capabilities taxonomy, and an information model.

3. The method of claim 1, wherein the services synthesis produces a list of required services.

4. The method of claim 1, wherein the services synthesis uses a role hierarchy and role information defined by the role analysis.

5. The method of claim 1, wherein the organization design defines at least one organization based on the role analysis and services synthesis.

6. The method of claim 1, wherein the transformation planning produces a services mapping wherein required services are mapped to at least one of an organization and an information technology application.

7. The method of claim 1, wherein at least some steps are performed iteratively.

8. A data processing system having at least a processor and accessible memory, comprising:
means for receiving role analysis data;
means for receiving services data to perform a services synthesis;
means for receiving organization design data; and
means for receiving transformation planning data and to produce therefrom a service-oriented transformation plan.

9. The data processing system of claim 8, wherein the data processing system produces from the role analysis data at least one of a role hierarchy, a capabilities taxonomy, and an information model.

10. The data processing system of claim 8, wherein the data processing system produces from the services synthesis data a list of required services.

11. The data processing system of claim 8, wherein the data processing system combines the services data with a role hierarchy according to the role analysis data.

12. The data processing system of claim 8, wherein the organization design data defines at least one organization based on the role analysis data and services data.

13. The data processing system of claim 8, wherein the data processing system produces from the transformation planning data a services mapping wherein required services are mapped to at least one of an organization and an information technology application.

14. A computer program product tangibly embodied in a machine readable storage medium, comprising:
instructions for receiving role analysis data;
instructions for receiving services data to perform a services synthesis;
instructions for receiving organization design data; and
instructions for receiving transformation planning data and to produce therefrom a service-oriented transformation plan.

15. The computer program product of claim 14, further comprising instructions for producing, from the role analysis data, at least one of a role hierarchy, a capabilities taxonomy, and an information model.

16. The computer program product of claim 14, further comprising instructions for producing, from the services synthesis data, a list of required services.

17. The computer program product of claim 14, further comprising instructions for combining the services data with a role hierarchy according to the role analysis data.

18. The computer program product of claim 14, further comprising instructions for defining at least one organization based on the role analysis data and services data.

19. The computer program product of claim 14, further comprising instructions for producing, from the transformation planning data, a services mapping wherein required services are mapped to at least one of an organization and an information technology application.

20. The computer program product of claim 14, wherein at least some instructions are executed iteratively.
